(19) United States
(12) Patent Application Publication
(10) Pub. No.: US 2010/0002747 A1
(43) Pub. Date: Jan. 7, 2010

(54) SYSTEM AND METHOD FOR N'TH ORDER DIGITAL PIECE-WISE LINEAR COMPENSATION OF THE VARIATIONS WITH TEMPERATURE OF THE NON-LINEARITIES FOR HIGH ACCURACY DIGITAL TEMPERATURE SENSORS IN AN EXTENDED TEMPERATURE RANGE

(76) Inventors: Enrique Company BOSCH, Alginet (ES); Alberto Sanchez PENARANDA, Alzira (ES); Javier Calpe Maravilla, Algemesi (ES); Alberto Carbajo Galve, San Antonio de Benageber (ES); John Anthony CLEARY, County Limerick (IE); Colin LYDEN, Cork (IE)

Correspondence Address: KENYON & KENYON LLP, 1500 K STREET, NW, WASHINGTON, DC, 20005-1257, US

(21) Appl. No.: 12/167,613

(22) Filed: Jul. 3, 2008

(51) Int. Cl. G01K 7/00

(52) U.S. Cl. 374/170; 374/E07.001

(57) ABSTRACT

A system and method is provided for a high accuracy digital temperature sensor (DTS). The system includes a differential analog temperature sensor based on bipolar junctions, providing an output signal obtained as the difference between the V_{BE} of two bipolar junctions. This signal is converted into the digital domain and compared to N−1 threshold digital values for providing piece-wise linear error correction for the variations with temperature of the different error sources within the DTS. This system and method advantageously improve the accuracy of a DTS over an extended temperature range.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

The present invention relates generally to sensors and more particularly to digital temperature sensors with correction techniques.

### BACKGROUND INFORMATION

High accuracy temperature measurements are required in a wide variety of applications such as medical, automotive and control. It is desirable that these digital temperature sensors (DTS) have low manufacturing costs. Standard CMOS processes are a very good option with regard to cost but do not have high-performance bipolar transistors which may be required for some functions. Therefore, substrate PNP (SPNP) transistors are used instead. However, these transistors are not usually well modeled, often leading to first-order approximations. Production calibration may be a solution to overcome some of these problems. However, the extremely high cost of having an absolute temperature reference (e.g. oil-bath) in high-volume production testing makes it not feasible. Thus, there is a need for a more accurate DTS system and method.

### BRIEF DESCRIPTION OF THE DRAWINGS

The invention is illustrated in the figures of the accompanying drawings, which are meant to be exemplary and not limiting, and in which like references are intended to refer to like or corresponding parts.

FIG. 1a shows a ΔV_{BE} generation diagram with a sequential scheme.

FIG. 1b shows a ΔV_{BE} generation diagram with a differential scheme.

FIG. 2 shows a block diagram of an embodiment of a high accuracy temperature sensor architecture.

FIG. 3 shows a diagram of the desired output code versus measured output code with no compensation of gain and offset.

FIG. 4 shows a diagram of the digital output code versus temperature with linear compensation.

FIG. 5 shows a diagram of the error when using the linear compensation technique.

FIG. 6 shows a diagram of a piece-wise linearization description.

FIG. 7 shows a diagram of the digital output code versus temperature with piece-wise linearization.

FIG. 8 shows a diagram with a comparison of the error introduced when using the linear compensation technique and the piece-wise linearization technique.

### DETAILED DESCRIPTION

A system and method are provided for a digital temperature sensor (DTS) with piece-wise gain and offset correction in the digital domain. In order to describe the benefits and features of the design of the DTS, it is instructive to divide the issues of measuring temperature into three different sub-issues, namely an analog temperature sensor based on generation of a proportional to temperature voltage (ΔV_{BE}), the reference voltage, and the analog to digital (A-to-D) converter. Each block has its own error sources which are addressed independently.

### Temperature Sensor

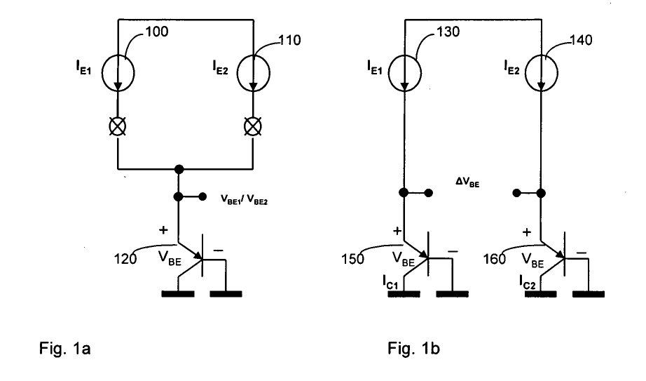

An accurate voltage proportional to temperature can be generated by applying two collector currents sequentially with the use of one SPNP, or simultaneously if one uses plurality of SPNPs. FIG. 1a shows a ΔV_{BE} generation diagram with a sequential scheme while FIG. 1b shows a differential scheme. The difference in base-emitter voltages is proportional to temperature, as illustrated in equation 1 below:

$$Δ {V}_{BE} = {V}_{BE 2} ( {I}_{C 2} ) - {V}_{BE 1} ( {I}_{C 1} ) = \frac{kT}{q} \cdot ln ( N ) ∝ {T}_{absolute} \qquad ( Eq . 1 )$$

where N is the ratio between I_{C2}/I_{C1}, k is Boltzmann's constant (1.38·10⁻²³ JK⁻¹), q is the electron charge (1.602·10⁻¹⁹ C), T is the absolute temperature. Assuming N=4, ΔV_{BE@25 C}=35.65 mV and it varies with a sensitivity of ΔV_{BE}/T=119.56 μV/K.

Equation 1 can be extended to include all the relevant non-idealities as illustrated in equation 2 below.

$$Δ {V}_{BE} = \overbrace{nf \cdot }^{1} \{ \overbrace{\frac{kT}{q} \cdot ln ( N )}^{2} + \overbrace{\frac{kT}{q} \cdot ln ( δ )}^{3} ++ \overbrace{\frac{kT}{q} \cdot ln ( \frac{( 1 + {β}_{1} ) \cdot {β}_{2}}{( 1 + {β}_{2} ) \cdot {β}_{1}} )}^{4} \} + \overbrace{{I}_{{E}_{1}} \cdot ( N - 1 ) \cdot {R}_{S}}^{5} \qquad ( Eq . 2 )$$

where:
1) is the non-ideality factor
2) is the ideal ΔV_{BE}
3) is the Current-Ratio Mismatch Error
4) is the Current-Gain Error which is a function of the different betas (β₁ and β₂) obtained at the two bias conditions (I_{C1} and I_{C2}).
5) is the Series Resistance Error, being R_{S} the combination of emitter resistance (R_{E}) and the base resistance (R_{B}).

The series resistance is provided by equation 3 below:

$${R}_{S} = {R}_{E} + \frac{{R}_{B}}{β + 1} \qquad ( Eq . 3 )$$

All the previous non-idealities (1-5) may cause non-linearities in the ΔV_{BE} generation, therefore it is beneficial to reduce the unwanted effects in equation 2 where possible in order to obtain a ΔV_{BE} as similar as possible to the ideal (term 2 in equation 2).

1) Non-Ideality Factor (n_{f})

Its effect can be assumed to be negligible.

### 3) Current-Ratio Mismatch Error

A stable current-ratio (N) can be obtained by a ratio of MOS devices.

Therefore, the mismatch between these devices substantially determines this error term. FIG. 1a shows a ΔV_{BE} generation diagram with a sequential scheme. Current sources 100 and 110 may comprise MOS devices or bipolar devices. Current sources 100 and 110 supply different currents sequentially to bipolar junction 120, establishing a V_{BE} ratio. In another embodiment, a differential ΔV_{BE} generation technique may be used. FIG. 1b shows a ΔV_{BE} generation diagram with a differential technique. In one embodiment, current sources 130 and 140, which comprise MOS devices, supply current to bipolar junctions 150 and 160 respectively. Alternatively, current sources 130 and 140 may comprise bipolar devices. Current shuffling techniques may be used to reduce this type of error, where a very accurate current-ratio can be achieved.

### 4) Current-Gain Error

The absolute value of the current unit and the ratio for current sources 100 and 110 of FIG. 1a, or current sources 130 and 140 of FIG. 1b, may be chosen such that, as a first order approximation, this error can be treated as a systematic offset and it can be characterized. In one embodiment, N=4 and I_{C1}=1 μA were chosen to minimize variations in sensor response due to SPNP beta differences at the two bias levels.

### 5) Series Resistance

Voltage drop across series resistance (R_{S}) may increase temperature errors. Several techniques can be applied to cancel this error out.

### Reference Voltage

The main error sources in a reference voltage affecting the accuracy of a DTS include:
1. Initial Accuracy: it is the maximum deviation from the output voltage at ambient temperature. It is expressed in % of the output voltage or in absolute values (volts).
2. Temperature Coefficient (TC): it is the drift of the output voltage over temperature. It is usually expressed in ppm/° C.
3. Voltage Noise: it is the noise at its output. It is expressed in volts for a given bandwidth.

The Initial Accuracy can provide an offset error at the output of a DTS. This error can be taken into account and minimized when calibrating the reference voltage absolute value.

The TC can be the main contributor to temperature error in a DTS. For example, for a reference TC of 100 ppm/° C., assuming the input voltage is 35.646 mV at +25° C. and 47.6 mV at +125° C. (this provides a sensitivity of 119.56 μV/K), the reference voltage may shift by 1% in the whole temperature range. The output voltage at +125° C. may be 47.6 mV+476.02 μV, yielding an error in the temperature reading of 3.98° C. Thus, the minimum reference TC for a particular configuration can be obtained as a function of the temperature error budget allowed in the application. It may be beneficial to use a state-of-art voltage reference to obtain high-accuracy in a DTS.

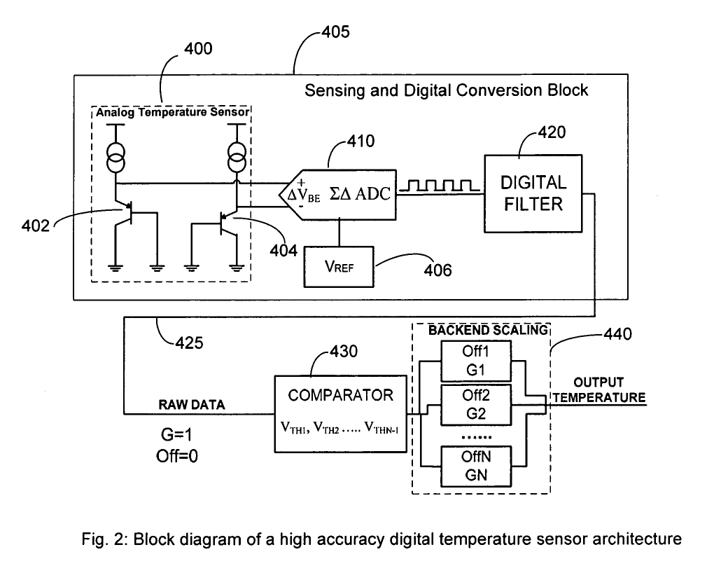

Voltage Noise at the output of the reference voltage, 406 of FIG. 2, can be important because it is involved at the input of the ADC 410 and it mixes with the input signal.

### Analog to Digital Converter

The ADC 410 converts the analog input signal from the analog temperature sensor 400 to a digital signal representing the temperature 425. The transfer function of an ideal A-to-D converter is shown in equation 5.

$$Code = ( \frac{{V}_{IN}}{{V}_{REF}} \cdot {2}^{b} - Offset ) \cdot Gain \qquad ( Eq . 5 )$$

where b is the ADC number of bits, and Offset and Gain are two digital calibration words accommodating the A-to-D errors.

Some requirements for the ADC to be used in a DTS include: resolution, accuracy (or errors), and bandwidth. In one embodiment of the present invention, the resolution of the ADC 410 may be sufficient to make converter quantization errors negligible. ADC 410 errors (offset, gain drift and non-linearities) can contribute to reduce the overall DTS accuracy. Therefore, it is beneficial to reduce these converter errors. In an embodiment of the present invention, a bandwidth below tens of Hertz can suffice. Thus, the design offers flexibility such that many types of converters could meet these requirements.

In light of the requirements discussed above, an embodiment of the present invention can include Sigma-Delta (ΣΔ) A-to-D converters 410. In another embodiment, Successive-Approximation (SAR) A-to-D converters are suitable architectures for high performance temperature measurements. Both achieve high-linearity and high-accuracy. Because bandwidth is not a primary constraint, in an embodiment of this invention, a high-resolution ΣΔ A-to-D converter with low offset and gain drift can be used.

FIG. 2 shows a block diagram of an embodiment of a high accuracy temperature sensor architecture. In this embodiment, a temperature sensor 400 uses the temperature dependent voltage of semiconductor junctions 402 and 404. For example, the base-emitter junction of a bipolar transistor pair 402 and 404 can be used. A current shuffling technique can be used to reduce the error in the current ratio between the two junctions. This differential analog voltage is coupled to an ADC 410. In an embodiment, a second order Sigma-Delta analog-to-digital converter (Σ-Δ ADC) 410 with its output coupled to a SINC³ digital filter 420 may be used. For example, the analog output signal from the temperature sensor 400 can be digitized with a resolution of 16 bits. In one embodiment, no gain and/or offset are applied to the signal in the analog domain. However, the temperature sensor and the ADC have an intrinsic gain/offset that is present in the output digital code (digital representation signal 425).

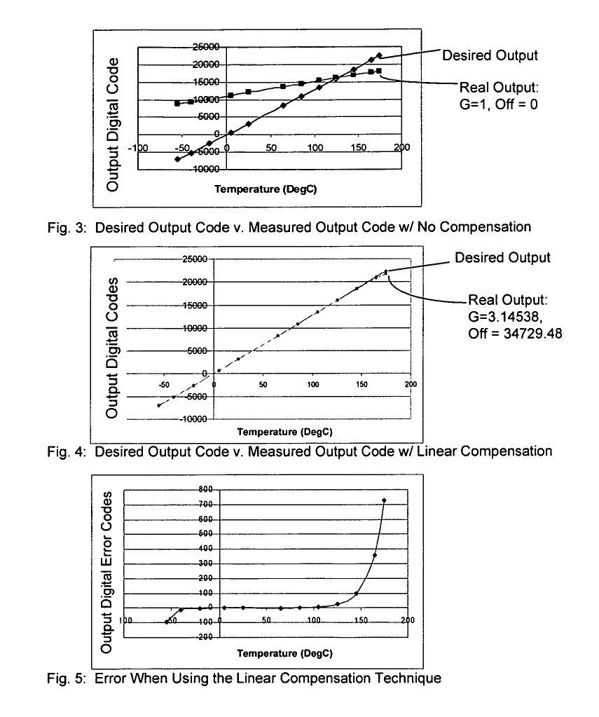

FIG. 3 shows a diagram of the desired output code versus measured output code with no compensation of gain and offset, i.e. G=1 and Off=0. The temperature range expands from −55° C. to +175° C. while the filter output code ranges from 8833@−55° C. to 17932@175° C. In this figure, the desired output of the digital temperature sensor is represented, too. In one embodiment, the desired output code, represented in decimal format, ranges from −7040@−55° C. to 22400@175° C.

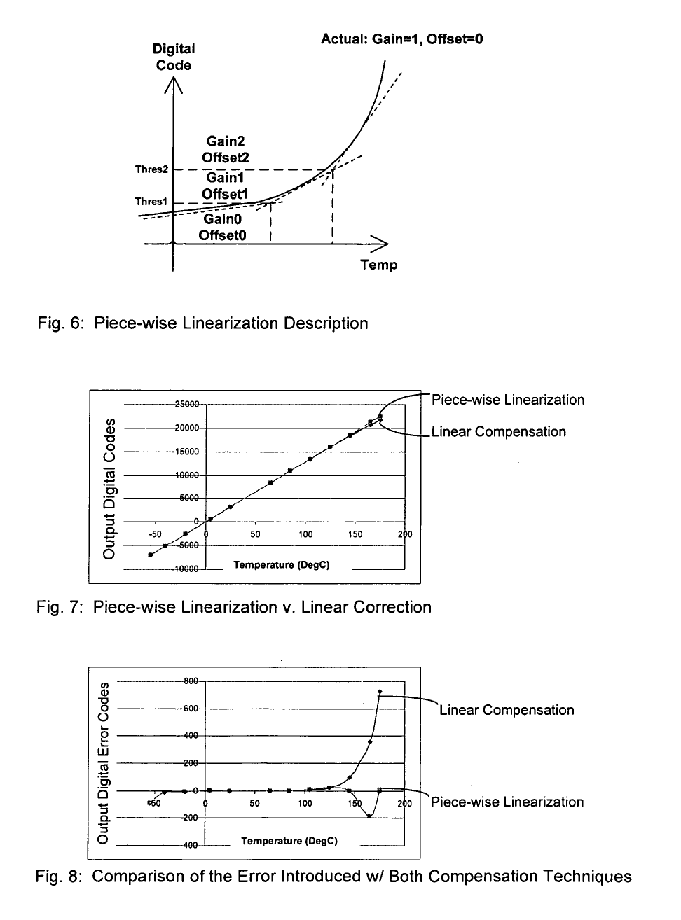

By applying a gain and an offset in the digital domain 440 to the digital signal representing the temperature 425, comprising raw digital data, the signal 425 can be brought closer to the desired output, as illustrated in FIG. 4. This figure illustrates the response after applying G=3.14538 and Off=34729.48 to the raw digital data (G=1, Off=0) in FIG. 3. Thus, the compensated output is closer to the desired output. FIG. 5 shows a diagram of the error between the desired result and the linear compensation technique. In the example of FIG. 5 the error is constant and almost negligible from −40° C. to 125° C. However, beyond 125° C., the error increases substantially. This error can be reduced by applying different gain/offset values for different temperatures. For example, if the error signal in FIG. 5 is divided into 3 different regions, a straight line within each region can be obtained to best fit the error curve. Thus, a different gain/offset value within each region can be applied. This N'th order piece-wise linearization technique is shown in FIG. 6. The number of regions chosen for the piece-wise linearization may depend on the maximum error allowed for the applications. In this exemplary embodiment, the maximum error is 200 digital codes, i.e. 1.25° C. The error may be further reduced by increasing the number of regions.

In one embodiment, the piece-wise linearization can be implemented by comparing the output code of the digital filter 420 against a multiplicity of threshold digital values in the comparator 430. For example, to yield 3 different temperature regions, 2 thresholds may be used. Once the active region is determined, the best gain/offset pair can be selected to minimize the error. The embodiment of the high accuracy temperature sensor architecture of FIG. 2 shows how a comparator 430 is used to compare the digital filter 420 output raw data 425 against N−1 threshold digital values. Depending on the result of the comparison, a different gain/offset pair 440 is used to adjust the raw data (the digital representation signal) 425 to the desired output. Thus, the temperature sensor is adjusted in the digital domain through backend scaling 440 of the raw data 425. For example, in one embodiment, the following procedure for choosing offsets/gains can be used:

If RawData <= threshold1→Gain=gain1, Offset=offset1
If threshold1 < RawData <= threshold2→Gain=gain2, Offset=offset2
If threshold2 < RawData <= threshold3→Gain=gain3, Offset=offset3
If threshold3 < RawData <= threshold4→Gain=gain4, Offset=offset4
If threshold4 < RawData <= threshold5→Gain=gain5, Offset=offset5

..................................................

If thresholdN−2 < RawData <= thresholdN−1→Gain=gainN−1,
Offset=offsetN−1
If RawData > thresholdN−1→Gain=gainN, Offset=offsetN

In another embodiment, hysteresis may be added to prevent repeatedly coming in and out of 2 gain/offset pairs when the temperature is at a threshold. The threshold comparison can be based on two 16-bit digital comparators 430. For example, the first comparator may compare if the raw data 425 is <=the threshold and the second comparator may compare if the raw data 425 is >the threshold. The output of these comparators 430 enables/disables the different gains/offsets. These values can be stored in poly-fuses, ROM, EEPROM, or any other digital storage device. It is understood that the procedure and description above is simply exemplary and that one skilled in the art would be able to vary values and ranges based on the concepts presented above.

FIG. 7 shows a diagram with a comparison of the error introduced when using the linear compensation technique and the piece-wise linearization technique. Thus, in the linear compensation technique only 1 gain/offset is used to adjust the digital output data. In contrast, the piece-wise linearization technique example uses 3 regions and 2 threshold points. FIG. 8 illustrates a comparison of the error introduced when using the linear compensation technique and the piece-wise linearization technique. This figure provides the deviation of the approximation obtained with either technique with respect to the desired output. Thus, FIG. 8 shows the error over temperature obtained by the examples of both techniques. At about 125° C., the error in the linear compensation technique is substantially larger than the piece-wise linearization technique. Furthermore, at higher temperatures, the error grows exponentially in the linear compensation technique.

In principle, it is beneficial if sensor response is linear with temperature, however, as previously explained, there are several factors which may cause the temperature sensor output to vary from a linear response. These factors can include:

Sensor gain and offset

Transistor non-ideality factor n_{f}

Current ratio mismatch error

Current gain error

Transistor series resistance

Voltage reference errors

ADC errors

Careful design of all the blocks in FIG. 2 can minimize the above factors. These factors can be calibrated out when choosing a gain and offset combination 440. However, accurate calibration of these terms is valid as far as 125° C. (see FIG. 5). Above this temperature, their temperature coefficient (TC) increases the error exponentially. In one embodiment, a piece-wise linear approximation with 3 regions (3 different gain/offset pairs) minimizes the total error below 200 digital codes. The error is further reduced by increasing the number of regions. The larger the number of regions, the smaller the error but more values may need to be stored. In one embodiment, the values are stored within the IC. These values include offset/gain pairs for corresponding thresholds. Piece-wise linearization correction is performed in the digital domain. Thus, piece-wise linearization compensates the temperature drift of all the terms mentioned above, and not only sensor sensitivity and offset TC.

Those skilled in the art will readily understand that the concepts described above can be applied with different devices and configurations. Although the present invention has been described with reference to particular examples and embodiments, it is understood that the present invention is not limited to those examples and embodiments. The present invention as claimed, therefore, includes variations from the specific examples and embodiments described herein, as will be apparent to one of skill in the art. Accordingly, it is intended that the invention be limited only in terms of the appended claims.

What is claimed is:

1. A digital temperature sensor circuit comprising:
a differential analog temperature sensor providing an analog output signal based on a difference between base-to-emitter voltages of at least two bipolar junctions;
an analog to digital converter coupled to the analog temperature sensor, providing a digital representation of the analog output signal; and
a comparator for comparing the digital representation signal to a plurality of predetermined thresholds, wherein a gain and offset pair based on the comparison is applied to the digital representation signal in the digital domain for N'th order piece-wise linear correction of the digital representation signal.

2. The digital temperature sensor circuit according to claim 1, wherein the differential analog temperature sensor includes a shuffling scheme current source.

3. The digital temperature sensor circuit according to claim 1, wherein the number of predetermined thresholds is one less than the number of different gain and offset pairs.

4. The digital temperature sensor circuit according to claim 1, further comprising a digital filter, and wherein the analog to digital converter comprises a sigma-delta converter with its output coupled to the digital filter.

5. The digital temperature sensor circuit according to claim 1, wherein hysteresis prevents repeatedly coming in and out of gain and offset pairs when the digital representation signal is at any of the plurality of predetermined thresholds.

6. The digital temperature sensor circuit according to claim 4, wherein the sigma-delta converter is a successive approximation analog to digital converter.

7. The digital temperature sensor circuit according to claim 4, wherein the digital filter is a SINC³ digital filter.

8. A method of temperature sensing comprising:
providing an analog signal based on a difference between base-to-emitter voltages of at least two transistors;
converting the analog signal to a digital representation of the analog signal;
comparing the digital representation signal to a plurality of predetermined thresholds;
selecting a gain and offset pair based on the comparison; and
N'th order piece-wise-linear correcting the digital representation signal by applying the gain and offset pair in the digital domain.

9. The method of temperature sensing according to claim 8, wherein a shuffling scheme current source is used to supply current to the at least two transistors.

10. The method of temperature sensing according to claim 8, wherein the number of predetermined thresholds is one less than the number of different gain and offset pairs.

11. The method of temperature sensing according to claim 8, wherein the analog signal is converted to digital by a sigma-delta converter coupled to a digital filter.

12. The method of temperature sensing according to claim 8, wherein the analog signal is converted to digital by a successive approximation converter coupled to a digital filter.

13. The method of temperature sensing according to claim 8, wherein hysteresis prevents repeatedly coming in and out of the gain and offset pair when the digital representation signal is at any of the plurality of predetermined thresholds.

14. The method of temperature sensing according to claim 11, wherein the digital filter is a SINC³ digital filter.

15. A digital temperature sensor circuit comprising:
a sequential analog temperature sensor providing an analog output signal based on a base-to-emitter voltage ratio of a bipolar junction wherein a multiplicity of current sources supply current sequentially to the base-to-emitter junction;
an analog to digital converter coupled to the analog temperature sensor, providing a digital representation of the analog output signal; and
a comparator for comparing the digital representation signal to a plurality of predetermined thresholds, wherein a gain and offset pair based on the comparison is applied to the digital representation signal in the digital domain for N'th order piece-wise linear correction of the digital representation signal.

16. The digital temperature sensor circuit according to claim 15, wherein the sequential analog temperature sensor includes a shuffling scheme current source.

17. The digital temperature sensor circuit according to claim 15, wherein the number of predetermined thresholds is one less than the number of different gain and offset pairs.

18. The digital temperature sensor circuit according to claim 15, further comprising a digital filter, and wherein the analog to digital converter comprises a sigma-delta converter with its output coupled to the digital filter.

19. The digital temperature sensor circuit according to claim 15, wherein hysteresis prevents repeatedly coming in and out of gain and offset pairs when the digital representation signal is at any of the plurality of predetermined thresholds.

20. The digital temperature sensor circuit according to claim 18, wherein the sigma-delta converter is a successive approximation analog to digital converter.

21. The digital temperature sensor circuit according to claim 18, wherein the digital filter is a SINC³ digital filter.

22. A method of temperature sensing comprising:
providing an analog signal based on a base-to-emitter voltage ratio of a bipolar junction wherein a multiplicity of current sources supply current sequentially to the base-to-emitter junction;
converting the analog signal to a digital representation of the analog signal;
comparing the digital representation signal to a plurality of predetermined thresholds;
selecting a gain and offset pair based on the comparison; and
N'th order piece-wise-linear correcting the digital representation signal by applying the gain and offset pair in the digital domain.

23. The method of temperature sensing according to claim 22, wherein a shuffling scheme current source is used to supply current to the base-to-emitter junction.

24. The method of temperature sensing according to claim 22, wherein the number of predetermined thresholds is one less than the number of different gain and offset pairs.

25. The method of temperature sensing according to claim 22, wherein the analog signal is converted to digital by a sigma-delta converter coupled to a digital filter.

26. The method of temperature sensing according to claim 22, wherein the analog signal is converted to digital by a successive approximation converter coupled to a digital filter.

27. The method of temperature sensing according to claim 22, wherein hysteresis prevents repeatedly coming in and out of the gain and offset pair when the digital representation signal is at any of the plurality of predetermined thresholds.

28. The method of temperature sensing according to claim 25, wherein the digital filter is a SINC³ digital filter.
